(19) United States
(12) Patent Application Publication
(10) Pub. No.: US 2024/0011782 A1
(43) Pub. Date: Jan. 11, 2024

(54) Generation and Provision of Control Data for Vehicle Automated Driving Systems

(71) Applicant: TomTom Global Content B.V., Amsterdam (NL)

(72) Inventors: Cornelis Pieter Schuerman, Veldhoven (NL); Baris Can Kara, Geldrop (NL); Deba Prasad Saha, Eindhoven (NL); Philippe Dirkse, Soerendonk (NL); Edward van de Vorst, Eindhoven (NL)

(21) Appl. No.: 18/017,629

(22) PCT Filed: Aug. 30, 2021
(86) PCT No.: PCT/EP2021/073856

§ 371 Date: Jan. 23, 2023

(30) Foreign Application Priority Data
Sep. 1, 2020 (GB) 2013685.9

(51) Int. Cl. G01C 21/34; G01C 21/00; B60W 60/00

(52) U.S. Cl. CPC G01C 21/3461; G01C 21/3822; B60W 60/001

(57) ABSTRACT

A method for providing data to one or more vehicles for controlling respective automated driving systems of the one or more vehicles, the method comprising: receiving an indication of a vehicle fleet; obtaining, from a restriction repository storing restriction data that indicates one or more location-dependent driving automation restrictions for automated driving systems, restriction data that corresponds to a portion of a road network and that is applicable to the indicated vehicle fleet; generating, or performing an update process for, a driving automation restriction layer for an amount of map data that corresponds to the portion of the road network based on the obtained restriction data; and providing the amount of map data, with the driving automation restriction layer, to one or more vehicles in the vehicle fleet.

### FIELD OF THE INVENTION

The present invention relates to a method for providing data to one or more vehicles for controlling respective automated driving systems of the one or more vehicles, a method for a map data client of a vehicle to provide data for controlling an automated driving system of the vehicle, and systems and computer program for carrying out such methods.

### BACKGROUND OF THE INVENTION

Automated Driving (AD) systems for vehicles are well known. An AD system may operate in accordance with a so-called Operational Design Domain (ODD). ODDs are also well-known in the field of AD systems—see, for example: (a) “How Many Operational Design Domains, Objects, and Events?”, Philip Koopman et al, AAAI Workshop on Artificial Intelligence Safety, January 2019 and (b) “Taxonomy and Definitions for Terms Related to Driving Automation Systems for On-Road Motor Vehicles”, Recommended Practice, SAE J3016, June 2018, SAE International, the entire disclosures of which are incorporated herein by reference. An ODD relates to (or defines or comprises or specifies) one or more conditions (or constraints or operational limits) under which a given AD system is designed to function, or is considered to function safely, or under which (or the manner in which) a given AD system may or may not provide AD functionality. These conditions may include one or more of: (a) one or more environmental conditions (e.g. an AD system may be designed to operate only under certain light levels, temperatures, weather conditions, etc); (b) one or more geographical conditions (e.g. an AD system may be permitted or prohibited from operating in a certain geographical region, on specific roads, when the vehicle is in a specific lane on a motorway, etc.); (c) time-of-day restrictions (e.g. an AD system may be permitted or prohibited from operating at night or during rush hour, etc.); (d) the requirement for the presence or absence of one or more traffic or roadway characteristics (e.g. an AD system may be permitted or prohibited from operating on certain classes of road, such as motorways, or roads with a speed limit above a threshold, or based on the number of vehicles on the road, etc.). It will be appreciated that one or more other types of condition may be used additionally or alternatively for an ODD.

The ODD may be specified or defined by one or more rules (or attributes) that encode (or represent) the conditions for the ODD. The AD system may process the rules to determine an “ODD result”, namely whether or not the vehicle, or its AD system, is currently within the ODD, i.e. that the vehicle is in an ODD compliant environment for the AD system. Based on this ODD result, the AD system can determine whether or how it may operate to control the vehicle. The rules may be location dependent or location independent. The rules may be dynamic or static. The rules may be issued or specified by various entities, such as road authorities, OEMs, vehicle manufacturers, insurers, vehicle rental companies, etc.

The vehicle side processing to determine the ODD result is often computationally intensive, particularly as the ODD becomes more complex. However, accurate determination and specification of the ODD is an important safety aspect for an AD system, to help ensure safety for vehicles and people in and around the road network.

### SUMMARY OF THE INVENTION

Currently, vehicles and AD systems receive, via separate delivery channels or from separate providers, (i) the rules for determining the ODD result for a current vehicle location and (ii) map data used by the AD systems (or other vehicle components in communication with the AD system). This therefore requires identification, or association, of rules with various geographic features by one or more systems at the vehicle (be that an AD system itself or other systems in communication with the AD system) so that the ODD result can be determined. This can become difficult, or require substantial processing at the vehicle-side, particularly when the map data and the rules for the ODD are provided by different entities, in different formats and may not share a common geographical frame of reference. This also makes it more difficult for AD system developers or vehicle manufacturer to design and test AD systems functionality.

The present invention addresses these problems by providing map data to a vehicle, where the map data that is provided (and that the vehicle therefore receives) has a driving automation restriction layer. This driving automation restriction layer may comprise or specify one or more attributes (or rules) for use in determining the ODD result. Each attribute is associated with a respective segment of a road network and may therefore be used for controlling operation of an AD system for that segment. By ensuring that such attributes are provided to, and received at, the vehicle as part of a layer already associated with the map data provided to the vehicle, the vehicle-side processing can be substantially reduced and safety can be improved.

Therefore, according to a first aspect of the invention, there is provided a method for providing data to one or more vehicles for controlling respective automated driving systems of the one or more vehicles, the method comprising: obtaining an indication of a vehicle fleet; obtaining, from a restriction repository storing restriction data that indicates one or more location-dependent driving automation restrictions for automated driving systems, restriction data that corresponds to a portion of a road network and that is applicable to the indicated vehicle fleet; generating, or performing an update process for, a driving automation restriction layer for an amount of map data that corresponds to the portion of the road network based on the obtained restriction data; and providing the amount of map data, with the driving automation restriction layer, to one or more vehicles in the vehicle fleet.

The driving automation restriction layer may comprise one or more driving automation restriction attributes, each driving automation restriction attribute associated with a respective segment of the portion of the road network and for controlling operation of automated driving systems for that segment.

The obtained restriction data may comprise at least one driving automation restriction indicated as applicable to a corresponding geographical feature of a map, in which case said generating, or performing an update process for, the driving automation restriction layer may comprise specifying the at least one driving automation restriction as one or more driving automation restriction attributes associated with map data for a road element of the road network corresponding to geographical feature.

The obtained restriction data may comprise at least one driving automation restriction indicated as applicable to a geographic region, in which case said generating, or performing an update process for, the driving automation restriction layer may comprise specifying the at least one driving automation restriction as one or more driving automation restriction attributes associated with map data for one or more road elements of the road network located within that geographic region.

The obtained restriction data may comprise at least one driving automation restriction indicated as applicable to road elements of the road network that have a specific property, in which case generating, or performing an update process for, the driving automation restriction layer may comprise specifying the at least one driving automation restriction as one or more driving automation restriction attributes associated with map data for one or more road elements of the road network that have the specific property.

The method may comprise receiving a request for map data from the vehicle, the request indicating the portion of the road network. The method may then further comprise identifying the vehicle fleet based on the received request.

The method may comprise receiving a restriction input to provide new restriction data for the restriction repository or an update to restriction data stored in the restriction repository for a location-dependent driving automation restriction. The restriction input may be provided by an entity associated with the vehicle fleet, wherein the restriction input is for restriction data for a location-dependent driving automation restriction specific to vehicles in the vehicle fleet. Alternatively, the restriction input may be for restriction data for a location-dependent driving automation restriction applicable to all vehicles.

The method may comprise providing a user interface for specifying the restriction input, wherein the user interface uses map data stored in a map repository for visualization of at least a part of the road network and for enabling a user to identify one or more geographic features for the restriction input.

The restriction repository may store, for each of a plurality of vehicle fleets, respective restriction data applicable to that vehicle fleet.

According to a second aspect of the invention, there is provided a system provided for providing data to one or more vehicles for controlling respective automated driving systems of the one or more vehicles, the system arranged to: obtain an indication of a vehicle fleet; obtain, from a restriction repository storing restriction data that indicates one or more location-dependent driving automation restrictions for automated driving systems, restriction data that corresponds to a portion of a road network and that is applicable to the indicated vehicle fleet; generate, or perform an update process for, a driving automation restriction layer for an amount of map data that corresponds to the portion of the road network based on the obtained restriction data; and provide the amount of map data, with the driving automation restriction layer, to one or more vehicles in the vehicle fleet.

Such a system may be arranged to carry out any of the methods according to the first aspect of the invention.

According to a third aspect of the invention, there is provided a method for a map data client of a vehicle to provide data for controlling an automated driving system of the vehicle, the method comprising: the map data client obtaining, from a system arranged to carry out any of the methods according to the first aspect of the invention (e.g. a system according to the second aspect of the invention), an amount of map data that corresponds to a portion of a road network and that has a driving automation restriction layer; the map data client identifying, based on the driving automation restriction layer and a specified geographic feature, one or more driving automation restriction attributes corresponding to the specified geographic feature, the one or more driving automation restriction attributes for use to control operation of the automated driving system; and providing the one or more driving automation restriction attributes to the driving automation system.

According to a fourth aspect of the invention, there is provided a map data client for a vehicle, the map data client arranged to provide data for controlling an automated driving system of the vehicle by: obtaining, from a system arranged to carry out any of the methods according to the first aspect of the invention (e.g. a system according to the second aspect of the invention), an amount of map data that corresponds to a portion of a road network and that has a driving automation restriction layer; identifying, based on the driving automation restriction layer and a specified geographic feature, one or more driving automation restriction attributes corresponding to the specified geographic feature, the one or more driving automation restriction attributes for use to control operation of the automated driving system; and providing the one or more driving automation restriction attributes to the driving automation system.

According to a fifth aspect of the invention, there is provided a computer program which, when executed by one or more processors, causes the one or more processors to carry out any method according to the first or third aspect of the invention. The computer-program may be stored on a computer-readable medium.

### BRIEF DESCRIPTION OF THE DRAWINGS

Embodiments of the invention will now be described, by way of example only, with reference to the accompanying drawings, in which:

FIG. 1 schematically illustrates an example system according to some embodiments of the invention;

FIG. 2 schematically illustrates various components of a vehicle;

FIG. 3 is a flowchart illustrating a method, performed by a map provider system, for providing data to one or more vehicles for controlling respective automated driving systems of the one or more vehicles;

FIG. 4 is a flowchart illustrating a method, performed by a map data client of a vehicle to provide data for controlling an AD system of the vehicle; and

FIG. 5 schematically illustrates an example of a computer system.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

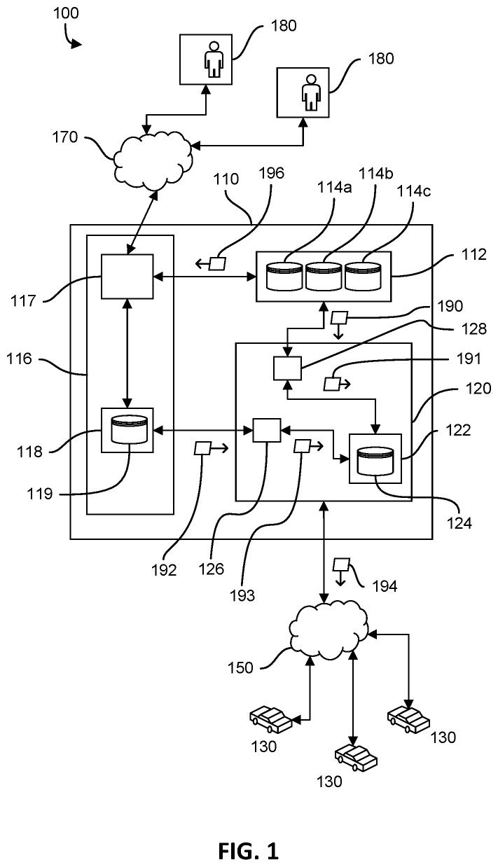

FIG. 1 schematically illustrates an example system 100 according to some embodiments of the invention. The system 100 comprises a map provider system 110, one or more vehicles 130, a first network 150, a second network 170 and one or more restriction providers 180. The map provider system 110 comprises: a map repository 112 comprising/storing one or more map databases 114; a driving automation restriction (DAR) system 116 that comprises a DAR management system 117 and a DAR repository 118 comprising/storing one or more DAR databases 119; and a data compiler system 120 that comprises a tile generator 128, a DAR layer generator 126 and a repository 122 comprising/storing one or more databases 124. FIG. 1 depicts three map databases 114 (namely map databases 114a, 114b and 114c), but it will be appreciated that this is merely exemplary and that other numbers of map databases 114 could be used.

In summary, the one or more map databases 114 store map data. The compiler system 120 may use its tile generator 128 to generate (or compile or collect) an amount (or a collection or a set) of map data 191 (referred to herein as a “tile”) relating to a portion of a geographic region or a portion of a road network. The tile generator 128 may generate the tile 191 based on map data 190, obtained from the one or more map databases 114, relating to that portion of the geographic region or that portion of the road network. The tile generator 128 may store the generated tile 191 in the database 124. The one or more DAR databases 119 store restriction data. Restriction providers 180 may interact with the DAR management system 117 via the second network 170 to manage (e.g. provide, update or delete) restriction data of the one or more DAR databases 119. The compiler system 120 may use its DAR layer generator 126 to generate, or update, a layer 193 (herein a “driving automation restriction layer” or “DAR layer”) for, or corresponding to, the tile 191 (i.e. for, or corresponding to, the portion of the geographic region or the portion of the road network associated with the tile 191). The DAR layer generator 126 may generate the DAR layer 193 based on restriction data 192, obtained from the one or more DAR databases 119, relating to that portion of the geographic region or that portion of the road network. This may involve creating the DAR layer 193 for the first time, and storing the DAR layer 193 as a layer for the tile 191 in the database 124, or updating a previously-created DAR layer 193 for the tile 191 currently stored in the database 124. The data compiler system 120 provides the tile 191, with its DAR layer 193, as map data 194 (or a map tile) to one or more of the vehicles 130 via the first network 150, for use to control AD systems of those vehicles 130.

The map provider system 110 may be implemented as a cloud-based system/service.

As mentioned, the one or more map databases 114 store map data. Thus, the map repository 112 is able to store and provide access to this map data. The map data may be in one or more forms or formats, may be of one or more corresponding types, and may be suitable for one or more corresponding purposes. For example, the map data may comprise one or more of:
1. A first type of map data (sometimes referred to as “SD” map data or “Standard Definition” map data), which provide an “SD map”, namely a model or representation of geospatial reality for a portion of a geographical region including a road network. This map data represents stationary features (such as road infrastructure features for the road network) that are relevant for vehicle navigation systems. The SD map data may include a graph representation of the road network, with the graph comprising arcs and nodes. The graph may be directed or undirected. The arcs are connected by nodes. The arcs and nodes of an SD map are associated with, or correspond to, road segments and connections of road segments, respectively. For the nodes, the SD map data comprises data for an associated point geometry, e.g. coordinates corresponding to the location of the node, or the connection, in the geographical region. Arcs have an associated road trajectory line, often referred to as a road centreline, representing the geometry of the road segment. The SD map data comprises data for the geometry of the arcs. The SD map data may store other data relating to node and/or arcs (e.g. speed limits applicable to road segments).
2. A second type of map data (sometimes referred to as “ADAS” map data or “Advanced Driver Assistance System” map data), which provide a model or representation of geospatial reality for a geographical region including a road network. The ADAS map data may be viewed as a particular type of SD map data. The ADAS map data represents stationary features (such as road infrastructure features for the road network, for example road curvature and road gradient) that are relevant for ADAS functions (such as predictive cruise control).
3. A third type of map data (sometimes referred to as “HD” map data or “High Definition” map data), which provide an “HD map”, namely a model or representation of geospatial reality for a portion of a geographical region including a road network. This map data represents stationary features (such as road infrastructure features for the road network) relevant for AD systems. The HD map data may include a graph representation of the road network, with the graph comprising arcs and nodes. The graph may be directed or undirected. The arcs are connected by nodes. The arcs and nodes of the HD map are associated with, or correspond to, road areas and connections of road areas, respectively. For some arcs, referred to as road arcs, the associated road area is one or more lanes of a road segment. For some arcs, referred to as junction arcs, the associated area is a road junction. For the nodes, the HD map data comprises data for an associated point geometry, e.g. coordinates corresponding to the location of the node, or the connection, in the geographical region. Road arcs have an associated road trajectory line (or road centreline) representing the geometry of the road segment and may have one or more lane trajectory lines (or lane centrelines) representing the geometry of a respective lane of the road segment. The geometry of a junction area may be specified by one or more junction arcs. A junction area may also have one or more junction arcs corresponding to the geometry of a respective permitted manoeuvre at that junction—for example, for each entry lane into that junction, there may be a junction arc corresponding to a manoeuvre to each exit lane from that junction accessible from that entry lane. The HD map data comprises data for the geometry of the arcs. Given the greater resolution and level of detail of HD map data compared to SD map data (such as having data relating to manoeuvres and to individual lanes as opposed to a road segment in general), HD map data is better suited to providing AD functionality/features.

Thus, the map data stored in the one or more map databases 114 comprises one or more geographic features, i.e. one or more map elements for, as aspects of, a road network, such as the above-described junctions/nodes and road segments etc. for SD and ADAS maps, or the above-described junctions/nodes, road segments, lanes (or segments thereof), groups of lanes (or segments thereof), etc. for HD maps.

Different types of map data may be stored in respective map databases 114. For example, the map database 114a may store SD map data, the map database 114b may store ADAS map data, and the map database 114c may store HD map data. Alternatively, the map databases 114 may each store one or more types of map data for a corresponding geographic region or road network. It will be appreciated that other configurations of one or more map databases 114 and the data stored therein are possible, and that embodiments of the invention may involve different types and different combinations of types of map data. As such map data is well-known, it shall not be described in further detail herein.

As mentioned, the one or more DAR databases 119 store restriction data. Thus, the DAR repository 118 is able to store and provide access to this restriction data. The restriction data defines, or represents, one or more DARs, i.e. one or more conditions (or constraints or operational limits) to control whether and/or the manner in which a given AD system (or a component or feature thereof) provides automated driving (or some aspect thereof). A DAR may relate to a condition under which the AD system has been designed to function (or operate), or is considered to function safely. DARs may be used to define, or specify, an ODD for the AD system. For example, a DAR may relate to one or more of: (a) one or more environmental conditions (e.g. the DAR may specify that an AD system is permitted or prohibited from performing automated driving under certain light levels, temperatures, weather conditions, etc); (b) one or more geographical conditions (e.g. the DAR may specify that an AD system is permitted or prohibited from performing automated driving in a certain geographical region, on specific roads, when the vehicle is in a specific lane on a motorway, or that the AD system is permitted or prohibited from performing automated driving for a certain manoeuvre at a junction, or that the AD system is prohibited from performing automated driving outside of a certain geographical region so as to constrain automated driving to within that region, etc.); (c) time-of-day restrictions (e.g. the DAR may specify that an AD system is permitted or prohibited from performing automated driving at night or during rush hour, etc.); (d) the requirement for the presence or absence of one or more traffic or roadway characteristics (e.g. the DAR may specify that an AD system is permitted or prohibited from performing automated driving on certain classes of road, such as motorways, or roads with a speed limit above a threshold, or based on the number of vehicles on the road, etc.). It will be appreciated that DARs may relate to one or more other types of conditions for an ODD. DARs may be either location dependent or location independent. DARs may be either dynamic or static. DARs may be vehicle type dependent and/or vehicle model dependent and/or vehicle manufacturer dependent, or may be independent of the vehicle type, vehicle model and vehicle manufacturer. Some DARs may specify a condition under which automated driving is allowed or prohibited (i.e. under which an AD system may or may not provide AD functionality), whilst other DARs may specify a manner in which AD functionality is to be provided under certain conditions (e.g. automated driving is permitted only in certain lanes or under a certain speed). Some DARs may relate to an AD system as a whole, whilst other DARs may relate to one or more components or functions of an AD system—therefore, discussion herein of controlling an AD system includes controlling one or more functions or components of an AD system.

The DAR management system 117 provides a mechanism by which entities can specify (or input, edit, manage, etc.) DARs for storage, as restriction data, in the DAR repository 118 and/or update or delete DARs currently being stored, as restriction data, in the DAR repository 118. For this, the DAR management system 117 may provide a website (or one or more webpages or a web application) accessible via the second network 170 by one or more restriction providers 180. As shall be described in more detail later, the DAR management system 117 may make use of map data 196, obtained from the map repository 112, to generate and provide a visual representation of a geographical area of a road network for use by a restriction provider 180 to specify a DAR.

The second network 170 may be any kind of network suitable for transmitting or communicating data between the DAR management system 117 and a restriction provider 180. For example, the second network 170 could comprise one or more of a local area network, a wide area network, a metropolitan area network, the internet, a wireless communications network, a cable network, a satellite communication network, a telephone network, etc. The DAR management system 117 and the restriction provider 180 may communicate over the second network 170 via any suitable communication mechanism/protocol in order to communicate data with each other. However, it will be appreciated that other communication scenarios are possible.

Whilst FIG. 1 depicts only one second network 170 it will be appreciated that embodiments of the invention may involve multiple second networks 170.

The restriction provider 180 may be any entity suitable for managing (e.g. adding/creating, updating, or deleting) DARs. For example, the restriction provider 180 may be one of: a vehicle manufacturer (that may specify DARs in relation to AD systems deployed in vehicles manufactured by that vehicle manufacturer); an AD system manufacturer (that may specify DARs in relation to AD systems manufactured by that AD system manufacturer); a vehicle rental company (that may specify DARs for AD systems in vehicles rented out by that company); an operator of vehicles (that may specify DARs for AD system of vehicles operated by that operator, such as an operator of city-centre e-bikes etc.); a road authority (that may specify DARs in relation to one or more roads of a road network, or a portion thereof, managed by that road authority). It will be appreciated that one or more restriction providers 180 may be other entities that specify or manage DARs via the DAR management system 117. Each restriction provider 180 may make use of any suitable computing system for interacting with the DAR management system 117, such as a personal computer, laptop, tablet, mobile telephone, etc.

Some DARs may be applicable to all types or category of vehicle (regardless of vehicle manufacture or vehicle model or vehicle owner, etc.)—examples of this include some DARs that may be provided by a road authority, such as a DAR which prohibits any automated driving on a certain road segment or in a certain geographic region or at certain times of day. On the other hand, some DARs may be applicable to one or more respective specific types or categories of vehicle, referred to herein as a “fleet” of vehicles. Such a fleet of vehicles may, for example, be: vehicles made by one or more specific vehicle manufactures; or vehicles of one or more specific models; or vehicles with a DA system of a specific type; or vehicles with one or more specific characteristics (e.g. lorry, car, weight above a threshold, engine size above a threshold, etc.); or vehicles owned by a certain entity (such as a vehicle rental company); etc. Such fleet-specific DARs may be provided by various restriction providers 180—for example, a vehicle manufacturer may provide DARs in relation to all vehicles and/or specific vehicle models made by that vehicle manufacturer and/or vehicles made by that vehicle manufacturer having a specific DA system; a manufacture of a particular DA system may provide DARs that will be applicable to all of vehicles having that particular DA system; a road authority may provide DARs in relation to all vehicles with one or more specific characteristics (as discussed above); a vehicle rental company may provide DARs in relation to some or all vehicles rented out by that company; a vehicle fleet operator may provide DARs in relation to a fleet of vehicles operated/managed by that operator; etc.

Different types of restriction data may be stored in respective DAR databases 119. Alternatively, the DAR databases 119 may store restriction data for DARs provided by different entities (e.g. a DAR database 119 for a first vehicle manufacture, another DAR database 119 for a second vehicle manufacturer, another DAR database 119 for a road authority, etc.) It will be appreciated that other configurations of one or more DAR databases 119 and the data stored therein are possible.

As mentioned above, the data compiler system 120 is arranged to use its tile generator 128 to generate the map tile 191 based on map data 190 obtained from the one or more map databases 114. Map tiles and map tile generation are well-known in this field of technology, and shall therefore not be described in detail herein. However, in summary, the map tile 191 corresponds to a geographic area (e.g. a portion of a geographic region or a portion of a road network). The data compiler system 120 may use its tile generator 128 to generate multiple map tiles 191 for respective different geographic areas. The dimensions of the geographic area for a first map tile 191 may be different from the dimensions of the geographic area for second map tile 191—for example, map tiles for urban areas generally have smaller dimensions than map tiles for rural areas (as urban areas generally have a greater density of road segments than rural areas). The tile generator 128 may determine the respective geographical areas for the map tiles that tile generator 128 creates so that those map tiles have substantially the same quantity of corresponding map data. The tile generator 128 may query the map repository 112 to obtain map data 190 relevant to, or associated with, the geographic area for the map tile 191 being created. Thus, for example, the tile generator 128 may obtain: from the SD map database 114a, SD map data relating to nodes and arcs for connections and road segments located in the geographic area for the map tile 191; and/or, from the ADAS map database 114b, ADAS data relating to nodes and arcs for connections and road segments located in the geographic area for the map tile 191; and/or, from the HD map database 114c, HD map data relating to nodes and arcs for connections and road areas located in the geographic area for the map tile 191. It will be appreciated, of course, that the tile generator 128 may obtain different types of map data, and different combinations of map data. For example, a map tile 191 intended for vehicle navigation functionality may comprise just SD map data whereas a map tile 191 intended for automated driving functionality may comprise HD map data and/or ADAS map data (and possibly SD map data too). The tile generator 128 may process the various map data 190 obtained from the map repository 112 to form the map tile 191. For example, the tile generator 128 may generate associations between different units of map data 190 (e.g. an association between SD map data for a road segment and HD map data for a road area overlapping that road segment)—such associations may be stored as a layer, or as metadata, forming part of the map tile 191. The tile generator 128 may perform various re-formatting of some or all of the map data 190 (e.g. to cater for different map data in the map databases 114 potentially having been provided by different digital map creators who may use different formats for their data). Thus, the map tile 191 is a quantity of map data formed based on map data 190 obtained from the map repository 112 for a corresponding geographic area. As with the above-described HD and SD maps, the map tile 191 may comprises a graph representation of the road network within the corresponding geographic area, with the graph having nodes and arcs in a similar manner to those described above for the SD and HD maps. It will be appreciated, however, that the map tile 191 may take other forms with its data representing various respective elements or features of the road network within the corresponding geographic area.

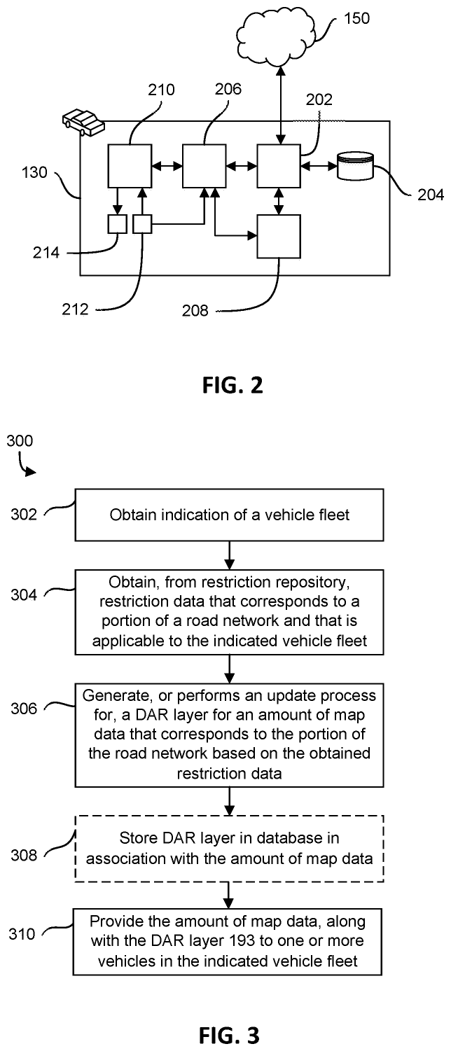

As mentioned above, the compiler system 120 may use its DAR layer generator 126 to generate a map layer, referred to herein as a DAR layer 193, corresponding to the tile 191. The notion of a map layer for a tile is well-known. As discussed above, the tile 191 contains map information (such as road segment and junction information) for the geographic area corresponding to the tile. A map layer contains additional information for the map information in a tile. This additional information may be relevant to a subset of map data clients (discussed later with respect to FIG. 2). A map layer thus enables introduction of further map information, e.g. in support of new functionality for map data client without disrupting legacy map data clients. For the DAR layer 193, the additional information relates to one or more location-specific DARs applicable to the geographic area for the tile 191. The DAR layer generator 126 may query the DAR repository 118 to obtain restriction data 192 that (a) indicates one or more location-dependent DARs that corresponds to the portion of the road network in the geographic area for the tile 191 and (b) are applicable to an indicated (or selected or specified) vehicle fleet. The DAR layer generator 126 may then generate the DAR layer 193 based on this restriction data 192 obtained from the DAR repository 118. This DAR layer 193 may, for example, comprise one or more DAR attributes, each DAR attribute being (a) associated with a respective segment of the portion of the road network (i.e. a respective road segment or graph arc represented by the tile 191) and (b) for controlling operation of an AD system for that segment or graph arc. Indeed, in some embodiments, a DAR attribute may be associated with a specific part of a road segment or graph arc represented by the tile 191 (e.g. by virtue of an offset parameter and a length parameter of the DAR attribute that indicates that the DAR is applicable to a portion of the road segment or graph arc beginning at an offset along that segment or arc and for a particular length along that segment or arc)—in this way, varying values for the DAR attribute may be specified for a particular road segment or graph arc. Examples of this shall be provided later, based on the different ways in which a restriction provider 180 may specify a DAR via the DAR management system 117 and how such DARs may be stored, or represented, as restriction data in the one or more DAR databases 118.

The DAR layer generator 126 may receive, or obtain, the tile 191 from the database 124 and then generate the DAR layer 193 for that tile 191.

The DAR layer 193 that is generated may be combined with the tile 191 for storage, together as a new tile, in the database 124. This may be carried out by the DAR layer generator 126 or by another module of the compiler system 120. Alternatively, the DAR layer 193 may be stored by the DAR layer generator 126 separately in the database 124, in association with (or linked to) the tile 191. Thus, for example, the DAR layer generator 126 may generate multiple DAR layers 193, each for a respective vehicle fleet, for the same tile 191.

As mentioned above, the compiler system 120 may use its DAR layer generator 126 to update a DAR layer 193, currently stored in the database 124, corresponding to the tile 191. The DAR layer generator 126 may query the DAR repository 118 to obtain restriction data that (a) indicates one or more location-dependent DARs that corresponds to the portion of the road network in the geographic area for the tile 191 and (b) are applicable to an indicated (or selected or specified) vehicle fleet and (c) that are different since the DAR layer 193 was last created/updated. In some embodiments, such updates may be performed in response to an event, e.g. when a vehicle 130 requests map data relating to the geographic area for the tile 191, or in response to the tile 191 itself being updated (such as when map data in the one or more map databases 114 is updated). In some embodiments, such updates may be performed periodically. In some embodiments, the DAR system 116 may trigger the update—for example, when the DAR system 116 receives an update for the restriction data stored by the DAR repository 118 (e.g. via the DAR management system 117), the DAR system 116 may notify the compiler system 120 that an update has been received (and potentially the geographical locations/areas involved in that location), so that the compiler system 120 may use its DAR layer generator 126 to perform an update process in respect of tiles 191 for which updated restriction data is available. It will be appreciated that the update process may be instigated, or performed, at other points in time and/or for other reasons.

The data compiler system 120 may provide the tile 191, with its DAR layer 193, as map data (or a map data tile) 194 to one or more vehicles 130 in the indicated vehicle fleet. This map data tile 194 may be provided to those one or more vehicles 130 in the vehicle fleet via the first network 150. The map data tile 194 is for use to control operation of AD systems of those vehicles 130 in the vehicle fleet.

The data compiler system 120 may provide the vehicles 130 with other data as necessary via the first network 150. For example, the data compiler system 120 may provide a vehicle 130 with a map data tile that does not have a DAR layer—e.g. a map data tile for route planning (e.g. a tile that comprises SD map data).

The first network 150 may be any kind of network suitable for transmitting or communicating data between the data compiler system 120 and the vehicles 130 (or map data clients thereof, as shall be discussed shortly with reference to FIG. 2). For example, the first network 150 could comprise one or more of a wide area network, a metropolitan area network, the internet, a wireless communications network, a satellite communication network, a telephone network, etc. In some embodiments, the first network 150 may comprise a content distribution network (CDN)— thus, the data compiler system 120 may provide the map data 194 to the CDN for storage on the CDN, with the vehicle 130 (or its map data client) retrieving or obtaining the map data 194 from the CDN at a later point in time. For this, the data compiler system 120 may provide the vehicle 130 (or its map data client) with an address on the CDN (e.g. a URL or some other link) for the stored map data 194 so that the vehicle 130 (or its map data client) can retrieve the map data 194 from that address. The vehicle 130 (or its map data client) and the data compiler system 120 may communicate over the first network 150 (possibly via one or more intermediaries, such as the above-mentioned CDN) via any suitable communication mechanism/protocol in order to communicate data with each other. However, it will be appreciated that other communication scenarios are possible.

Whilst FIG. 1 depicts only one first network 150 it will be appreciated that embodiments of the invention may involve multiple first networks 150.

Although FIG. 1 depicts the first network 150 and the second network 170 as two separate networks, in some embodiments they may be the same network and/or may use overlapping network infrastructure.

FIG. 2 schematically illustrates some of components of a vehicle 130 in more detail.

The vehicle 130 comprises: a map data client 202; a memory (or storage or cache) 204; an horizon system 206; a navigation system 208; an AD system 210; one or more sensors 212; and one or more actuators 214. The map data client 202, horizon system 206, navigation system 208 and AD system 210 each may be implemented as a hardware component of the vehicle 130, or as software executing on one or more processors of the vehicle 130, or as a mixture of both hardware and software.

The map data client 202 is arranged to obtain map data (e.g. as map data tiles) from the map provider system 110 via the first network 150. The map data client 202 may store some or all of this map data in the memory 204 for subsequent retrieval and provision to one or more components of the vehicle 130 for use by those components. Additionally, or alternatively, the map data client 202 may provide map data received via the first network 150 directly to one or more components of the vehicle 130 for use by those components. The memory 204 may store additional map data not provided by the map provider system 110 via the first network 150.

The navigation system 208 may receive navigation planning criteria, (e.g. input from a human driver or passenger within the vehicle 130) relating to an intended journey (e.g. start location, destination location, waypoints, etc.) and determine a navigation route based on the navigation planning criteria. For this, the navigation system 208 may use map data (such as SD map data) provided by the map data client 202 (e.g. map data received via the network 150 and/or from the memory 204, as discussed above). Such navigation systems 208 are well-known and shall not be described in detail herein.

Horizon systems 206 are well-known and shall not be described in detail herein. In summary, though, the horizon system 206 is responsible for obtaining/identifying map data that the AD system 210 may require for performing its AD functionality. The horizon system 206 typically determines which map data is most likely to be used and may pre-cache that data in a local storage for easy/quick access. This collection of map data is commonly referred to as the “horizon”. Thus, the horizon consists of map data covering predicted future locations of the vehicle 130. The horizon system 206 typically uses a most probable path to determine the horizon. The horizon may also cover alternate paths enabling the AD system 210 to respond to real-time events (e.g. accidents, evasive manoeuvres, driver intervention). For this, the horizon system 206 may make use of input from one or more of the sensors 212 to obtain a current location of the vehicle 130. There are several known techniques to determine a location, e.g. using GNSS (e.g. GPS), dead-reckoning relative to a previous location, or HD map matching (recognizing objects represented in the HD map based on input from one or more cameras or radar systems 212). The horizon system 206 may process the current location to determine an amount of map data that may be required by the AD system 210, e.g. according to the navigation route generated by the navigation system 208 (and optionally some or all of the navigation planning criteria too). The horizon system 206 may request this map data from the map data client 202—the map data client 202 may already have access to that amount of map data (e.g. if that map data is being stored in the memory 204) or the map data client 202 may request that amount of map data from the map provider system 110. Thus, map data may be provided to the vehicle 130 in response to such a request. In embodiments of the invention, this map data may include some or all of the map data tile 194.

The AD system 210 is responsible for performing automated driving functionality. Such AD systems 210 are well-known and shall not be described in detail herein. In summary, though, the AD system 210 may receive input from the one or more sensors 212 (e.g. data relating to the current location of the vehicle 130, data from one or more cameras or radar transmitter/receivers of the vehicle so that the AD system 210 can identify objects in the environment of the vehicle 130; etc.) and may request or obtain map data from the horizon system 206 for use in automated driving functionality. Based on the input from the one or more sensors 212 and the map data from the horizon system 206, the AD system 210 may control some or all of the driving of the vehicle 130 using the one or more actuators 214.

As discussed above, the AD system 210 needs to determine whether or not it is currently operating within its ODD (i.e. an ODD result). If the AD system 210 is operating within its ODD, then the AD system 210 may provide its driving automation functionality accordingly. If, on the other hand, the AD system 210 is not operating within its ODD, then the AD system 210 may determine that it cannot provide its driving automation functionality. Additionally or alternatively, if the AD system 210 is not operating within its ODD, then the AD system 210 may determine that one or more aspects of the driving automation functionality cannot be provided, whilst other aspects of the driving automation functionality can be provided (e.g. automated parking is permitted but automated driving along a road is not permitted). Additionally or alternatively, if the AD system 210 is not operating within its ODD, then the AD system 210 may determine that one or more aspects of the driving automation functionality must be provided in a particular manner (e.g. automated driving along a road is only permitted when within certain lanes or under certain speeds). For example, if the AD system 210 is not operating within its ODD, there may be a higher risk of AD system failure and so the AD system 210 may fall back to a safer mode of driving (e.g. handing control back to a human driver, making a manoevre to an ODD compliant part of the road network, bringing the vehicle to a stop in a safe manner, reducing the vehicle speed so that another mode of automated driving can be activated that is within its ODD for the current road segment/junction, etc). The AD system 210 may determine its current ODD based on map data received from the horizon system 206, with the horizon system 206 having requested and obtained that map data from the map data client 202. In particular, the AD system 210 may obtain (or be provided with) one or more DAR attributes in relation to one or more road features at or near the current location of the vehicle 130 (e.g. DAR attributes for the road segment and/or the lane and/or junction for the current location of the vehicle 130 and/or DAR attributes for one or more other nearby road segments and/or lanes and/or junctions). As mentioned, such AD systems 210 and their interaction with horizon systems 206, are well-known.

In embodiments of the invention, the DAR attributes used by the AD system 210 to determine its ODD (i.e. to control operation of the AD system 210) are DAR attributes that form part of the DAR layer 193 provided, with the map data 191, as part of the map data 194 from the map provider system 110.

FIG. 3 is a flowchart illustrating a method 300, performed by the map provider system 110, for providing data to one or more vehicles 130 for controlling respective automated driving systems 210 of the one or more vehicles 130.

At a step 302, the DAR layer generator 126 obtains (e.g. receives or determines) an indication of a vehicle fleet. This may occur in a variety of ways. For example:
1. As discussed above, in some embodiments the map tile 194 may be provided to a vehicle 130 in response to a request from that vehicle 130 for certain map data, with this request indicating a portion of the road network (to which the map tile 194 that gets delivered relates). The map provider system 110 may receive this request and identify the vehicle fleet based on the received request. In some embodiments, the request may contain an explicit indication of the vehicle fleet (e.g. the map data client 202 may be arranged to generate requests including such an explicit indication). In other embodiments, the map provider system 110 may process the request to determine the indication of the vehicle fleet (i.e. the indication may be indirect). For example, the request may contain an identification of the vehicle 130 and/or of the AD system 208 of the vehicle 130 and/or of the map data client 202 of the vehicle 130 and/or of some other component of the vehicle 130. The map provider system 110 may comprise (or have access to) a database that stores associations between such identifications and corresponding vehicle fleets—the map provider system 110 may query the database, using the identifier contained in the received request, to thereby obtain an indication of an associated vehicle fleet. Thus, the DAR layer generator 126 may obtain the indication of the vehicle fleet as (or based on) the vehicle fleet identified from the received request.
2. As discussed above, in some embodiments the DAR layers 193 that are stored in the database 124, may be periodically updated by the DAR layer generator 126 (e.g. as an automated/scheduled process). Each DAR layer 193 may be stored in association with an indication of the vehicle fleet to which that DAR layer 193 corresponds (e.g. the indication of the vehicle fleet may be stored as metadata or an attribute of the DAR layer 193). Thus, when the DAR layer generator 126 performs a periodic update of the DAR layers 193 stored in the database 124, the DAR layer generator 126 may, for a particular DAR layer 193 undergoing the update process, use the indication of the vehicle fleet associated with that particular DAR layer 193.
3. As discussed above, in some embodiments the DAR system 116 may notify the data compiler system 210 and/or the DAR layer generator 126 that restriction data in the DAR repository 118 has been updated. This notification may contain the indication of the vehicle fleet to which the updated restriction data corresponds. Additionally, or alternatively, the DAR layer generator 126 may obtain the indication of the vehicle fleet by accessing, or obtaining, updated restriction data 192 from the DAR repository 118.

It will be appreciated that the DAR layer generator 126 may receive, or obtain, the indication of the vehicle fleet by other methods and/or in response to other events.

At a step 304, the DAR layer generator 126 obtains, from the restriction repository 118 (that is storing restriction data that indicates one or more location-dependent DARs for AD systems 210), restriction data 192 that corresponds to a portion of a road network and that is applicable to the indicated vehicle fleet. This may occur in a variety of ways. For example:
1. As discussed above, in some embodiments the map tile 194 may be provided to a vehicle 130 in response to a request from that vehicle 130 for certain map data, with this request indicating a portion of the road network (to which the map tile 194 that gets delivered relates). The map provider system 110 may receive this request and identify the map tile 194 as being a tile to deliver to the vehicle 130. The DAR layer generator 126 may query the DAR repository 118 for restriction data corresponding to the geographical area for that map tile 194.
2. As discussed above, in some embodiments the DAR layers 193 that are stored in the database 124, may be periodically updated by the DAR layer generator 126. The DAR layer generator 126 may, for a particular DAR layer 193 undergoing the update process, query the DAR repository 118 for restriction data corresponding to the geographical area for that DAR layer 193.
3. As discussed above, in some embodiments the DAR system 116 may notify the data compiler system 210 and/or the DAR layer generator 126 that restriction data in the DAR repository 118 has been updated. The DAR system 116 may provide this updated restriction data to the DAR layer generator 126 (either directly or in response to a query from the DAR layer generator 126 for this updated restriction data once the DAR layer generator 126 has been informed that an update for the DAR repository has occurred). In this way, the steps 302 and 304 may take place as a single step.

It will be appreciated that the DAR layer generator 126 may receive, or obtain, the restriction data 192 by other methods and/or in response to other events. The restriction data 192 obtained may be all of the restriction data for the portion of the road network (to which the tile 191/194 relates) or may be restriction data pertaining to DAR changes that have occurred for the portion of the road network (to which the tile 191/94 relates) since the DAR layer 193 for the tile 191/194 was last created/updated.

At a step 306, the DAR layer generator 126 generates, or performs an update process for, the DAR layer 193 for an amount of map data (the map tile 191) that corresponds to the portion of the road network for the step 304. This generation, or update process, is performed based on the restriction data 192 obtained at the step 304. The nature of the DAR layer 193 has been discussed above. Various examples of how the DAR layer 193 may be generated or updated based on the restriction data 192 shall be described shortly.

At an optional step 308, the DAR layer generator 126 stores the DAR layer 193 produced at the step 306 in the database 124. In this way, the DAR layer 193 is available for updating at a future point in time (at step 306 when the method 300 is performed again), as opposed to having to completely regenerate the DAR layer 193 each time the method 300 is performed. As discussed above, the DAR layer 193 may be stored together with the amount of map data (the tile 191) as a single data object, or may be stored separately from the amount of map data (the tile 191) so that multiple different DAR layers 193 (for respective different vehicle fleets) may be associated with the amount of map data (the tile 191).

At a step 310, the map provider system 110 provides the amount of map data (the tile 191), along with the DAR layer 193, (together as the map tile 194) to one or more vehicles 130 in the indicated vehicle fleet. Methods for achieving this have been discussed above in relation to FIG. 1. For example, this may involve making the map tile 194 available for access/retrieval by the vehicles 130 in the indicated vehicle fleet (e.g. storing the map tile 194 on a CDN accessible to the vehicles 130 in the indicated vehicle fleet and providing the vehicles 130 in the indicated vehicle fleet with an address, or a link, from which the map tile 194 may be obtained from the CDN). Additionally, or alternatively, this may involve actively pushing the map tile 194 over the first network 150 to one or more vehicles 130 in the indicated vehicle fleet. It will be appreciated that other mechanisms for performing the step 310 may be used.

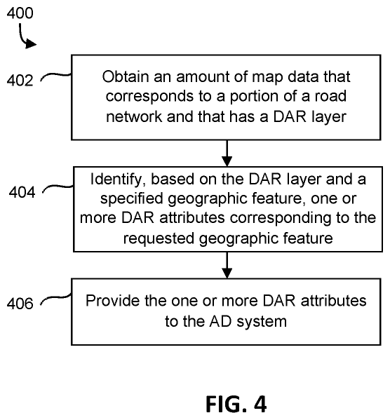

FIG. 4 is a flowchart illustrating a method 400, performed by the map data client 202 of the vehicle 130 to provide data for controlling the AD system 210 of the vehicle 130.

At a step 402, the map data client 202 obtains, from a system arranged to carry out the method 300 (e.g. the map provider system 110 or the data compiler system 120), an amount of map data (the map tile 194) that corresponds to a portion of a road network and that has a DAR layer (the DAR layer 193). Methods by which the map data may be provided to the map data client 202 have been discussed above.

The map data client 202 may request this map data, e.g. based on a route determined by the navigation system 208 or based on data which the horizon system 206 identifies as possibly being required at some point in the future for providing automated driving functionality. Additionally, or alternatively, the map data may be pushed to the vehicle (e.g. as part of proactive pre-caching of map data in the memory 204 based on a location of the vehicle 130).

At a step 404, the map data client 202 identifies, based on the DAR layer (the DAR layer 193) and a specified geographic feature, one or more DAR attributes corresponding to the specified geographic feature, the one or more DAR attributes for use to control operation of the AD system 210. For example, as discussed above, the horizon system 206 may request that the map data client 202 provides DAR attributes corresponding to one or more geographic features that may be encountered by the vehicle (e.g. based on a route determined by the navigation system 208). These geographic features could be, for example, one or more road segments, junctions, etc. As the DARs represented by the DAR layer 193 are location-dependent and are associated with features of the underlying map data (the map tile 191), the map data client 202 can identify DAR attributes in the DAR layer 193 for these DARs based on the location of the specified geographic features.

At a step 406, the map data client 202 provides the one or more DAR attributes to the AD system 210. This may involve providing the DAR attributes to the AD system 210 directly or via one or more other components of the vehicle, such as the horizon system 206.

As mentioned above, a restriction provider 180 may use, or interact with, the DAR management system 117 in order to specify one or more DARs. This may typically be achieved by the DAR management system 117 providing a website, or one or more webpages, accessible to the restriction provider 180 via the second network 170. It will be appreciated that other methods could be used instead, such as an application hosted by the DAR management system 117 or an application downloaded by, and executed by, the restriction provider 180. Whichever mechanism is used, a user interface may be provided to the restriction provider 180 via which the restriction provider 180 may manage DARs (e.g. add/create a new DAR, modify an existing DAR, cancel/delete an existing DAR, etc.). This may be achieved in a variety of ways, as set out below.

To assist the restriction provider 180 in managing DARs, one aspect of the user interface provided by the DAR management system 117 may include displaying a digital map (e.g. a visual representation of at least a portion of the road network). For this, the DAR management system 117 may obtain map data 196 from the map data repository 112. Such representations of road networks are well-known and shall not be described in more detail herein. Such a displayed map aids with visualization of at least a part of the road network, to enable a user (the restriction provider 180) to identify one or more geographic features for a DAR.

The restriction provider 180 may specify the nature of the DAR (e.g. permit or prohibit automated driving; indicate a particular manner by which automated driving should be performed; indicate a vehicle fleet to which the DAR applies; etc.) via any suitable mechanism (e.g. from a list of options presented to the restriction provider 180). In some embodiments, the DAR management system 117 may automatically identify a vehicle fleet to which the DARs for this restriction provider 180 are to apply—for example, if the restriction provider 180 is an insurer, then the DAR management system 117 may identify that the fleet of vehicles to which DARs of this restriction provider 180 are applicable are vehicles insured by that insurer. The restriction provider 180 may be provided with an opportunity to change the vehicle fleet accordingly, or to specify a new vehicle fleet.

The restriction provider 180 may identify one or more specific road segments or other geographic features/elements (e.g. nodes or arcs as discussed above). This could be achieved, for example, by selecting junctions (or specific manoeuvres at junctions), road segments or lanes thereof, on the digital map presented on the user interface as discussed above; by selecting one or more junctions (or specific manoeuvres at junctions), roads, or segments or lanes thereof, from a list of junctions, roads or road segments (e.g. a list of motorways), etc. Thus, the DAR management system 117 may generate restriction data for a DAR that has been indicated as applicable to this geographical feature/element. In this case, the step 306 of FIG. 3, (i.e. the generating, or performing an update process for, the DAR layer 193) may comprise the DAR layer generator 126 identifying (as necessary) one or more map elements (e.g. road segments, nodes, road arcs, junction arcs, etc) of the map tile 191 that correspond to the geographic feature(s)/element(s) identified by the restriction provider 180. The step 306 may then involve specifying the DAR as one or more DAR attributes associated with map data (of the map tile 191) for those one or more map elements of the tile 191. The one or more DAR attributes may indicate the nature of the DAR (specified by the restriction provider 180, as discussed above). The one or more DAR attributes may be linked, or associated with, the identified one or more map elements of the tile 191. For example, each element (e.g. a node, a road segment, an arc, etc.) in the map tile 191 may have a corresponding identifier and the one or more DAR attributes for this DAR may be stored in the DAR layer 193 as data associated with the identifier for the identified one or more map elements.

The system may be arranged so that the above-mentioned identifier that is used for identifying a map element may persist across different map versions, provided that the map element has not changed substantially. For example, if a new version of map data is generated that reflects a change to a road segment, but not a change at the road level, then the new version of the map data may use the same identifier for that road segment as was used in the preceding version of the map data. The system may make use of one or more rules for deciding when a change to a road segment should result in a new identifier for that (changed) road segment or should result in the current identifier being maintained for that (changed) road segment. As an example, a change to the geometry of the road segment may result in a new identifier if the change exceeds a certain threshold, whereas the previous identifier is retained if the change to the geometry of the road segment does not exceed that threshold (e.g. a new identifier is used if the new curvature of the road segments differs from the previous curvature of the road segment by above a threshold). As another example, a change to the lanes of the road segment (e.g. lane entries/exits or markings on the road) may result in a new identifier if the change exceeds a certain threshold, whereas the previous identifier is retained if the change does not exceed that threshold. It will be appreciated that these are merely examples of some rules that may be implemented in an attempt to maintain/preserve identifiers. Maintaining identifiers in this way helps reduce the amount of additional processing that may be required in response to an update to the map data—e.g. if an identifier of a road segment changes, then the DAR layer 193 may need to be regenerated/updated to account for that change.

The restriction provider 180 may identify a geographic region. This could be achieved, for example, by indicating the region on the digital map presented on the user interface as discussed above (e.g. by drawing a bounded region on the digital map); by selecting one or more regions from a list of regions (e.g. a list of states, countries, counties, etc.). Thus, the DAR management system 117 may generate restriction data 192 for a DAR that has been indicated as applicable to this geographic region. In this case, the step 306 of FIG. 3, (i.e. the generating, or performing an update process for, the DAR layer 193) may comprise the DAR layer generator 126 identifying (as necessary) one or more map elements (e.g. road segments, nodes, road arcs, junction arcs, etc) of the map tile 191 that are located (at least partially) within the identified geographic region. The step 306 may then involve specifying the DAR as one or more DAR attributes associated with map data (of the map tile 191) for those one or more map elements of the tile 191. The one or more DAR attributes may indicate the nature of the DAR (specified by the restriction provider 180, as discussed above). The one or more DAR attributes may be linked, or associated with, the identified one or more map elements of the tile 191. For example, each element (e.g. a node, a road segment, an arc, etc.) in the map tile 191 may have a corresponding identifier and the one or more DAR attributes for this DAR may be stored in the DAR layer 193 as data associated with the identifier for the identified one or more map elements.

The restriction provider 180 may identify one or more properties (or characteristics) for road elements of a road network, such as gradient, curvature, width, etc. This could be achieved, for example, by selecting one or more properties from a list of properties and, optionally, one or more values and/or rules for that property (e.g. a threshold value and that the DAR is to apply to road elements for which the property exceeds the threshold value). Thus, the DAR management system 117 may generate restriction data 192 for a DAR that has been indicated as applicable to road elements of the road network that have a specific property. In this case, the step 306 of FIG. 3, (i.e. the generating, or performing an update process for, the DAR layer 193) may comprise the DAR layer generator 126 identifying (as necessary) one or more map elements (e.g. road segments, nodes, road arcs, junction arcs, etc) of the map tile 191 that have that specific property. The step 306 may then involve specifying the DAR as one or more DAR attributes associated with map data (of the map tile 191) for those one or more map elements of the tile 191. The one or more DAR attributes may indicate the nature of the DAR (specified by the restriction provider 180, as discussed above). The one or more DAR attributes may be linked, or associated with, the identified one or more map elements of the tile 191. For example, each element (e.g. a node, a road segment, an arc, etc.) in the map tile 191 may have a corresponding identifier and the one or more DAR attributes for this DAR may be stored in the DAR layer 193 as data associated with the identifier for the identified one or more map elements.

The restriction provider 180 may identify, or specify, one or more standards or regulations that provide an agreed set of one or more DARs for an AD system. One such example standard or regulation is UN regulation 79 (see, for example, https://treaties.un.org/Pages/ViewDetails.aspx?src=TREATY&mtdsg_no=XI-B-16-79&chapter=11&clang=_en, the entire disclosure of which is incorporated herein by reference). For example, a standard or regulation may specify that an AD system may only be allowed to provide certain driving assistance (such as steering control or lane keeping functionality) for a road segment (or lane arc or junction arc) if that road segment satisfies one or more properties, such as: (i) pedestrians and cyclists are prohibited on that road segment; (ii) the road segment is equipped with a physical separation (e.g. a barrier) that divides the traffic moving in opposite directions; and (iii) there are at least two lanes in the direction of travel. In this case, the step 306 of FIG. 3, (i.e. the generating, or performing an update process for, the DAR layer 193) may comprise the DAR layer generator 126 identifying (as necessary) one or more map elements (e.g. road segments, nodes, road arcs, junction arcs, etc) of the map tile 191 that, according to the standard or regulation, are suitable for providing the AD functionality indicated in that standard or regulation, i.e. that are map elements for which, according to that standard or regulation, that AD functionality is allowed/permitted. The step 306 may then involve specifying the DAR as a DAR attribute associated with map data (of the map tile 191) for those one or more map elements of the tile 191. The DAR attribute may indicate that those one or more map elements comply with the standard or regulation, such that that AD functionality is permitted on those one or more map elements. The DAR attribute may be linked, or associated with, the identified one or more map elements of the tile 191. For example, each element (e.g. a node, a road segment, an arc, etc.) in the map tile 191 may have a corresponding identifier and the DAR attribute may be stored in the DAR layer 193 as data associated with the identifier for the identified one or more map elements.

The user interface may indicate, to the restriction provider 180, existing DARs that the restriction provider 180 is allowed to edit. This could be achieved by providing a list of such DARs. Alternatively, the above-mentioned map display may provide a visual indication of DARs and the location (e.g. road segments or lane arcs or junction arcs) to which the DARs correspond, via which the restriction provider 180 may select a particular DAR. It will be appreciated that other mechanisms may be used to enable a restriction provider 180 to select one or more existing DARs. The restriction provider 180 may then delete a selected DAR or may change one or more properties of the DAR (in the same way in which properties of the DAR may be specified for a new DAR, as discussed above).

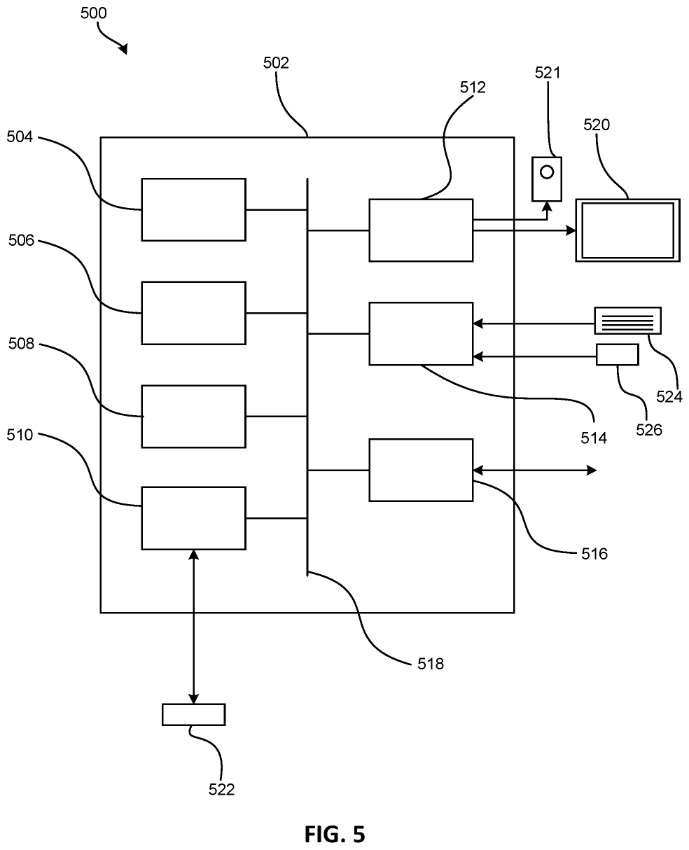

FIG. 5 schematically illustrates an example of a computer system 500. The system 500 comprises a computer 502. The computer 502 comprises: a storage medium 504, a memory 506, a processor 508, an interface 510, a user output interface 512, a user input interface 514 and a network interface 516, which may be linked together over one or more communication buses 518.

The storage medium 504 may be any form of non-volatile data storage device such as one or more of a hard disk drive, a magnetic disc, a solid-state-storage device, an optical disc, a ROM, etc. The storage medium 504 may store an operating system for the processor 508 to execute in order for the computer 502 to function. The storage medium 504 may also store one or more computer programs (or software or instructions or code).

The memory 506 may be any random access memory (storage unit or volatile storage medium) suitable for storing data and/or computer programs (or software or instructions or code).

The processor 508 may be any data processing unit suitable for executing one or more computer programs (such as those stored on the storage medium 504 and/or in the memory 506), some of which may be computer programs according to embodiments of the invention or computer programs that, when executed by the processor 508, cause the processor 508 to carry out a method according to an embodiment of the invention and configure the system 500 to be a system according to an embodiment of the invention. The processor 508 may comprise a single data processing unit or multiple data processing units operating in parallel, separately or in cooperation with each other. The processor 508, in carrying out data processing operations for embodiments of the invention, may store data to and/or read data from the storage medium 504 and/or the memory 506.

The interface 510 may be any unit for providing an interface to a device 522 external to, or removable from, the computer 502. The device 522 may be a data storage device, for example, one or more of an optical disc, a magnetic disc, a solid-state-storage device, etc. The device 522 may have processing capabilities—for example, the device may be a smart card. The interface 510 may therefore access data from, or provide data to, or interface with, the device 522 in accordance with one or more commands that it receives from the processor 508.

The user input interface 514 is arranged to receive input from a user, or operator, of the system 500. The user may provide this input via one or more input devices of the system 500, such as a mouse (or other pointing device) 526 and/or a keyboard 524, that are connected to, or in communication with, the user input interface 514. However, it will be appreciated that the user may provide input to the computer 502 via one or more additional or alternative input devices (such as a touch screen). The computer 502 may store the input received from the input devices via the user input interface 514 in the memory 506 for the processor 508 to subsequently access and process, or may pass it straight to the processor 508, so that the processor 508 can respond to the user input accordingly.

The user output interface 512 is arranged to provide a graphical/visual and/or audio output to a user, or operator, of the system 500. As such, the processor 508 may be arranged to instruct the user output interface 512 to form an image/video signal representing a desired graphical output, and to provide this signal to a monitor (or screen or display unit) 520 of the system 500 that is connected to the user output interface 512. Additionally or alternatively, the processor 508 may be arranged to instruct the user output interface 512 to form an audio signal representing a desired audio output, and to provide this signal to one or more speakers 521 of the system 500 that is connected to the user output interface 512.

Finally, the network interface 516 provides functionality for the computer 502 to download data from and/or upload data to one or more data communication networks.

It will be appreciated that the architecture of the system 500 illustrated in FIG. 5 and described above is merely exemplary and that other computer systems 500 with different architectures (for example with fewer components than shown in FIG. 5 or with additional and/or alternative components than shown in FIG. 5) may be used in embodiments of the invention. As examples, the computer system 500 could comprise one or more of: a personal computer; a server computer; a tablet; a laptop; etc. Additionally, it is possible that some components of the computer system 500 are not located in a personal computer, server system or a laptop and are part of a computer network connected to the personal computer, server system or a laptop via the network interface 516 and are located in a cloud of the computer network.

The restriction providers 180 may make use of one or more such computer systems 500 to interact with the DAR management system 117 via the second network 170. The map provider system 110 (and components thereof) may be implemented as, or execute on, one or more such computer systems 500 (e.g. as a cloud-based service).

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or one or more graphical processing units (CPUs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then one or more storage media and/or one or more transmission media storing or carrying the computer program form aspects of the invention. The computer program may have one or more program instructions, or program code, which, when executed by one or more processors (or one or more computers), carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, byte code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1-20. (canceled)

21. A method for providing data to one or more vehicles for controlling respective automated driving systems of the one or more vehicles, the method comprising:
obtaining an indication of a vehicle fleet;
obtaining, from a restriction repository storing restriction data that indicates one or more location-dependent driving automation restrictions for automated driving systems, restriction data that corresponds to a portion of a road network and that is applicable to the indicated vehicle fleet;
generating, or performing an update process for, a driving automation restriction layer for an amount of map data that corresponds to the portion of the road network based on the obtained restriction data; and
providing the amount of map data, with the driving automation restriction layer, to one or more vehicles in the vehicle fleet.

22. The method of claim 21, wherein the driving automation restriction layer comprises one or more driving automation restriction attributes, each driving automation restriction attribute associated with a respective segment of the portion of the road network and for controlling operation of automated driving systems for that segment.

23. The method of claim 21, wherein the obtained restriction data comprises at least one driving automation restriction indicated as applicable to a corresponding geographical feature of a map, and wherein said generating, or performing an update process for, the driving automation restriction layer comprises specifying the at least one driving automation restriction as one or more driving automation restriction attributes associated with map data for a road element of the road network corresponding to geographical feature.

24. The method of claim 21, wherein the obtained restriction data comprises at least one driving automation restriction indicated as applicable to a geographic region, and wherein said generating, or performing an update process for, the driving automation restriction layer comprises specifying the at least one driving automation restriction as one or more driving automation restriction attributes associated with map data for one or more road elements of the road network located within that geographic region.

25. The method of claim 21, wherein the obtained restriction data comprises at least one driving automation restriction indicated as applicable to road elements of the road network that have a specific property, and wherein generating, or performing an update process for, the driving automation restriction layer comprises specifying the at least one driving automation restriction as one or more driving automation restriction attributes associated with map data for one or more road elements of the road network that have the specific property.

26. The method of claim 21, comprising receiving a request for map data from the vehicle, the request indicating the portion of the road network.

27. The method of claim 26, comprising identifying the vehicle fleet based on the request.

28. The method of claim 21, comprising receiving a restriction input to provide new restriction data for the restriction repository or an update to restriction data stored in the restriction repository for a location-dependent driving automation restriction.

29. The method of claim 28, wherein the restriction input is provided by an entity associated with the vehicle fleet, wherein the restriction input is for restriction data for a location-dependent driving automation restriction specific to vehicles in the vehicle fleet.

30. The method of claim 28, wherein the restriction input is for restriction data for a location-dependent driving automation restriction applicable to all vehicles.

31. The method of claim 28, comprising providing a user interface for specifying the restriction input, wherein the user interface uses map data stored in a map repository for visualization of at least a part of the road network and for enabling a user to identify one or more geographic features for the restriction input.

32. The method of claim 21, wherein the restriction repository stores, for each of a plurality of vehicle fleets, respective restriction data applicable to that vehicle fleet.

33. The method of claim 21, comprising receiving a restriction input to provide new restriction data for the restriction repository or an update to restriction data stored in the restriction repository for a location-dependent driving automation restriction.

34. A method for a map data client of a vehicle to provide data for controlling an automated driving system of the vehicle, the method comprising:
the map data client obtaining, from a system arranged to carry out the method of any one of the preceding claims, an amount of map data that corresponds to a portion of a road network and that has a driving automation restriction layer;
the map data client identifying, based on the driving automation restriction layer and a specified geographic feature, one or more driving automation restriction attributes corresponding to the specified geographic feature, the one or more driving automation restriction attributes for use to control operation of the automated driving system; and
providing the one or more driving automation restriction attributes to the driving automation system.

35. A system comprising one or more processors arranged to carry out a method according to claim 1.

36. The system of claim 35, wherein the driving automation restriction layer comprises one or more driving automation restriction attributes, each driving automation restriction attribute associated with a respective segment of the portion of the road network and for controlling operation of automated driving systems for that segment.

37. The system of claim 35, wherein the obtained restriction data comprises at least one driving automation restriction indicated as applicable to a corresponding geographical feature of a map, and wherein said generating, or performing an update process for, the driving automation restriction layer comprises specifying the at least one driving automation restriction as one or more driving automation restriction attributes associated with map data for a road element of the road network corresponding to geographical feature.

38. The system of claim 35, wherein the obtained restriction data comprises at least one driving automation restriction indicated as applicable to a geographic region, and wherein said generating, or performing an update process for, the driving automation restriction layer comprises specifying the at least one driving automation restriction as one or more driving automation restriction attributes associated with map data for one or more road elements of the road network located within that geographic region.

39. The system of claim 35, wherein the obtained restriction data comprises at least one driving automation restriction indicated as applicable to road elements of the road network that have a specific property, and wherein generating, or performing an update process for, the driving automation restriction layer comprises specifying the at least one driving automation restriction as one or more driving automation restriction attributes associated with map data for one or more road elements of the road network that have the specific property.

40. A non-transitory computer readable storage medium storing instructions that, when executed by one or more processors, causes the one or more processors to perform a method according to claim 1.
